(19) United States
(12) Patent Application Publication
(10) Pub. No.: US 2010/0305808 A1
(43) Pub. Date: Dec. 2, 2010

(54) Method and System for Transmitting Data

(75) Inventor: Jürgen Littwin, Villingen-Schwenningen (DE)

Correspondence Address: COHEN, PONTANI, LIEBERMAN & PAVANE LLP, 551 FIFTH AVENUE, SUITE 1210, NEW YORK, NY, 10176, US

(73) Assignee: CONTINENTAL AUTOMOTIVE GMBH, Hannover (DE)

(21) Appl. No.: 12/808,545

(22) PCT Filed: Dec. 17, 2008
(86) PCT No.: PCT/EP2008/067783

§ 371 Date: Jun. 16, 2010

(30) Foreign Application Priority Data
Dec. 21, 2007 (DE) 10 2007 063 013.3
May 26, 2008 (DE) 10 2008 025 065.1

(51) Int. Cl. G06F 7/00

(52) U.S. Cl. 701/33

(57) ABSTRACT

A method and system for transmitting data via a transmission pathway between a tachograph, which is disposed in a vehicle, and a data processing facility, which is at a distance from the vehicle. Data is transmitted wirelessly via at least a partial section of the transmission pathway and the tachograph is connected to a GSM module and/or a module for wireless data transmission The method includes producing a connection for wireless transmission between the GSM module and/or the module for wireless data transmission and the data processing facility, instructing the tachograph by the data processing facility to receive specific data; authentically the data processing facility and/or the tachograph transmitting specific data to the tachograph.

### PRIORITY CLAIM

This is a U.S. national stage of Application No. PCT/EP2008/067783, filed on Dec. 17, 2008, which claims priority to the German Application No's: 10 2007 063 013.3, filed: Dec. 21, 2007, and 10 2008 025 065.1, filed May 26, 2008 the contents of which are incorporated herein by reference.

### BACKGROUND OF THE INVENTION

1. Field of the Invention

The invention relates to a method for transmitting data via a transmission path between at least one tachograph, arranged in a vehicle, and a data processing installation which is at a distance from the vehicle, and to an appropriate system for transmitting data via such a transmission path.

2. Related Art

Motor vehicles, particularly commercial vehicles, are often equipped with a tachograph to record, inter alia, the driving and rest periods for both the commercial vehicle and the drivers and co-drivers.

The data and further data stored and recorded in the tachograph firstly need to be noted and archived in a defined time window in line with legal regulations. Secondly, it is important to have an overview of the data to make reasonable use of a fleet comprising a plurality of motor vehicles or commercial vehicles.

In the prior art, tachographs are known that store the recorded data on paper disks in analog form. With the advent of the digital age in the field of tachographs, other opportunities arise for the storage, recording and subsequent archiving of data.

To update digital tachographs, the tachographs have, to date, needed to be brought to a workshop with appropriate equipment for servicing, so that the motor vehicles or commercial vehicles are not operational at this time. In this context, the tachograph is usually removed or a standardized interface is used to load specific data directly from the installation at the service center into the tachograph.

One drawback of this method is that the servicing of the tachographs within the workshop results in the vehicles in which the tachographs are arranged are not operational, which results in inefficiency in the utilization of the vehicles.

### SUMMARY OF THE INVENTION

An object of the invention is to specify a method and a system which allow simpler servicing of a tachograph during ongoing operation.

The method involves the use of a tachograph arranged in a vehicle and a data processing installation which is at a distance from the vehicle, wherein the data are transmitted from the data processing installation to the tachograph wirelessly at least via a subsection of the transmission path. In this case, the tachograph has an associated GSM module and/or an associated module for wireless data transmission and is connected thereto. By way of example, the module for wireless data transmission may be based on an IEEE-801.x standard, a Bluetooth standard, a wireless USB standard, a radio wave standard or an infrared wave standard. In this context, the tachograph may have one of the above two modules, two modules or else more than two modules.

First of all, a connection is set up between the GSM module and/or the module for wireless data transmission and the data processing installation for the purpose of wireless data transmission. The fact that the connection is made wirelessly allows data interchange between the tachograph associated with the GSM module and/or the module for wireless data transmission and the data processing installation to take place over a longer range. In particular, that the tachograph no longer needs to be in the direct region of a service center, but can also communicate with the data processing installation over long distances away from the data processing installation—for example the operating haulage company.

When a connection has been set up, the tachograph is instructed by the data processing installation to receive specific data. In this context, specific data is intended to be understood to be the data processing installation transmits selected information to the tachograph on the basis of the position or the model type of the tachograph or the level of experience of the driver or co-driver. This information is thus not exclusively data which by necessity need to be interchanged between the tachograph and the data processing installation on account of a previously selected transmission protocol. On the contrary, the data processing installation uses additional information in order to transmit the data which are suitable and needed for this tachograph.

The transfer of data or the servicing of the tachograph can take place independently of the whereabouts of the vehicle in which the at least one tachograph is arranged.

The authentication of the data processing installation on the at least one tachograph and/or of the at least one tachograph on the data processing installation ensures that in each case only one tachograph associated with the data processing installation is able to obtain information or specific data from the data processing installation. This is important particularly because the remote communication opportunities between the at least one tachograph and the data processing installation mean that the wirelessly transmitted data can be intercepted, manipulated and misused by a large number of receivers. The authentication, possibly with a secured connection, provides a remedy for this.

Following the authentication, the specific data is transmitted from the data processing installation to the at least one tachograph.

It is particularly advantageous if the specific data is stored in the tachograph. The storage of the specific data in the tachograph allows the data to be read from the data processing installation to the tachograph at a later time too, and not just at the time of the data transmission.

It is particularly advantageous if the specific data transmit information and at least portions of said information are displayed by a menu control of the tachograph or a display of the tachograph and/or are printed by a printer associated with the tachograph and/or are output by a voice output device associated with the tachograph. In this way, the driver or the co-driver can be provided with information transmitted by the data processing installation and is notified of said information immediately by the tachograph. It is likewise possible for the buffer-storage to provide that the specific data can be retrieved by the driver or co-driver at a later time.

In this context, it is particularly advantageous if the information contains telematic information. The data processing information can be used to collect telematic information. The telematic information may comprise routes, roadworks, route changes and queue warnings, for example. This information can be transmitted to the at least one tachograph via the data processing installation. This makes the tachograph part of a minimal traffic telematics solution, wherein it is particularly preferred if the at least one tachograph has an apparatus for inherent localization, such as a GPS module or a receiver for toll infrared waves or is connected thereto.

A further particularly advantageous variant of the method is characterized in that the specific data comprise an update for a data processing program of the tachograph. In this way, it is possible for software updates or firmware updates for the tachograph to be performed remotely. This allows portions of the updated data processing program or all of the updated data processing program to be received by the tachograph, stored and then installed, the installation being able to be performed either automatically or manually by the user of the tachograph. An update to be performed by a workshop can then be dispensed with, which reduces the servicing times for the vehicle.

It is particularly advantageous if a plurality of tachographs are present and the data processing installation communicates with the tachographs independently of one another. The data processing installation holds a large amount of information about the widest variety of tachograph models and the widest variety of vehicles associated with the tachographs. On account of the ability to communicate with the individual tachographs independently, the specific data can be matched to the respective tachograph, to the respective vehicle and to the driver currently driving the vehicle. This represents a great simplification particularly when a relatively large number of vehicles or commercial vehicles are being monitored, which occurs in the case of haulage companies. The data processing installation can take suitable algorithms as a basis for compiling the appropriate data for a particular vehicle, a particular tachograph model and the driver operating the vehicle and can then transmit specific data to the GSM module and/or the module for wireless data transmission of the respective tachograph.

It is advantageous if the GSM module and/or the module for wireless data transmission are arranged in a communication controller, and the communication controller is connected to the tachograph by a further interface. Using the communication controller, no severe physical alteration to the tachograph itself is necessary. The communication controller communicates with the tachograph via already present interfaces such as a CAN interface or serial or parallel interfaces and sets up the connection between the data processing installation and the tachograph. In this case, it is particularly advantageous if the specific data transmitted by the data processing installation can also be buffer-stored in the communication controller. This better compensates for transmission disturbances. In addition, it is advantageous if the specific data comprise an update for a data processing program of the communication controller. In this case, the same essentially applies as has been stated above in reference to the tachograph. In this way, it is possible for the software or firmware of the communication controller to be updated over long distances.

Preferably, the aforementioned methods and embodiments thereof and methods relating to said methods are carried out using a system for transmitting data.

The system has at least one tachograph arranged in a vehicle. In addition, a data processing installation is present which is arranged outside of the vehicle. Also, the at least one tachograph is connected to at least one GSM module and/or to a module for wireless data transmission from the data processing installation to the tachograph or is associated therewith. In this case, the data transmission between the data processing installation and the GSM module and/or module for wireless data transmission is wireless.

Such a system is outstandingly well suited to exploiting or implementing the advantages of the previously described methods.

### BRIEF DESCRIPTION OF DRAWINGS

The invention will be explained more precisely with reference to a few exemplary embodiments. In the figures:

FIG. 1 is a schematic illustration of a system with a tachograph and a data processing installation in one embodiment of the invention;

FIGS. 2a-2c are a schematic illustration of a method for data transmission from the data processing installation to the tachograph;

FIG. 3 is a schematic illustration of an update for a data processing program of a tachograph and of a communication controller; and

FIG. 4 is a schematic illustration of an appropriate system with a multiplicity of tachographs.

### DETAILED DESCRIPTION OF THE DRAWINGS

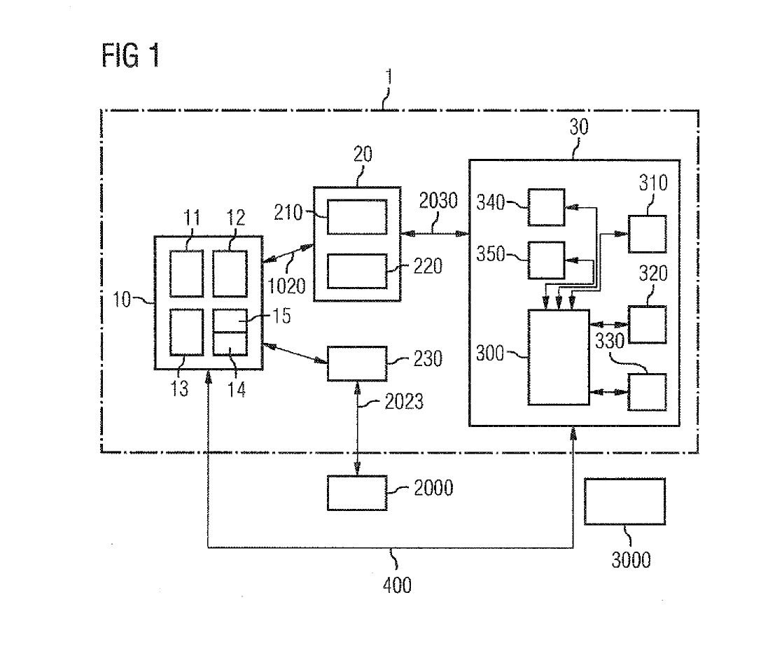

FIG. 1 shows a system 1 which has a digital tachograph 10, a communication controller 20 and a data processing installation 30.

The digital tachograph 10 comprises, inter alia, menu control or a display 11, a printer 12, a control unit 13, a first memory 14, and a second memory 15. The tachograph 10 may also comprise a voice output device.

In the present case, the communication controller 20 comprises a GSM module 210 and a module for wireless data transmission 220, wherein the module for wireless data transmission 220 is in control of a WLAN standard and a radio wave standard. That is to say that the module 220 can receive both IEEE-801.x standards and radio waves. An apparatus for inherent localization 230 is situated so as not to be arranged in the housing of the communication controller 20. The apparatus 230 is in contact with the tachograph 20. The apparatus for inherent localization 230 is used to transmit data to the tachograph 10 regarding its own whereabouts. In the present exemplary embodiment, the apparatus for inherent localization 230 is in the form of a GPS module. This communicates with a satellite system 2000 via a connection 2023.

The data processing installation 30 has a GSM module 340, the term “module” being understood to be that the data processing installation 30 has access to a GSM network which in turn can communicate with the GSM module 210 of the communication controller 20. In addition, the data processing installation 30 has a WLAN axis point 350 and can access the latter to communicate with the module for wireless data transmission 220 of the communication controller 20. A central element in the data processing installation 30 is a server 300. Server 300 holds information regarding the tachograph model of the digital tachograph 10, the scheduled route of the vehicle which contains the tachograph 10, and the driver driving the vehicle at this time. The data on the server 300 can be accessed using a fixed client 310 or using a web interface 320.

In addition, the server has an authentication apparatus 330 connected to it which is used for an authentication process with the tachograph 10.

The data processing installation 30 receives telematic information—provided that it does not hold this itself in the system—via an external information source 3000, which may be a radio station, a message service for data or the like.

The operation of individual elements of the system 1 will be discussed below. Apart from the elements 11 to 15, the tachograph 10 has further elements, which are not discussed in more detail at this juncture. These are apparatuses which are known from the prior art, such as standardized interfaces, power supplies, and maintenance access points.

The menu control or display 11 can be used to display information which has been transmitted from the data processing installation 30 to the GSM module 210 or module for wireless data transmission 220 and then reaches the tachograph 10 from said module via the connection 1020 from the communication controller. In this case, the menu control can also be used to make a selection for the information that is to be displayed. The same applies to the printer 12. The latter can also output information, the information being able to be selected beforehand or the nature of the information resulting by necessity in printing. The decision regarding whether information is forcibly displayed or printed, optionally displayed or printed or not displayed or printed is made by the control unit 13. The latter receives the specific data from the data processing installation 30 and evaluates them. The possibly present voice output device can also output any transmitted information.

The specific data transmitted by the data processing installation 30 are stored in the memory 14 or 15. The memory 14 is a memory that stores the firmware or the data processing program which is required for the operation of the tachograph 10. The memory 15 contains data, inter alia, specific data not absolutely necessary for the operation of the tachograph, but can be forwarded to the user via the aforementioned paths of the menu control or display 11 and the printer 12 and/or the voice output device.

In the exemplary embodiments, a portion of the memory 15 is in the form of a memory of a driver's card or a co-driver's card which can be inserted into the tachograph 10. This is thus not exclusively the memory fitted directly in the tachograph, but is also the memory in the form of driver's cards which is connected to the tachograph 10 indirectly.

The control unit 13 also receives the data from the apparatus for inherent localization 230 and can store such data in the memory 15.

In the embodiment shown here, the GSM module and the module for wireless data transmission are accommodated in an external communication controller 20. The latter is connected to the tachograph by a connection 1020, the connection 1020 being wire-based. A transmission path 400 between the tachograph 10 and the data processing installation 30 comprises the connection 1020, and the wireless subsection 2030. In this way, it is possible to accomplish data transmission between the data processing installation 30 and the tachograph 10 over long distances.

Naturally, the GSM module 210 and the module for wireless data transmission 220 can likewise be arranged directly in the tachograph 10 or can be connected to the tachograph 10 as individual modules. It is equally conceivable for the apparatus for inherent localization 230 to be accommodated in the communication controller 20 or the tachograph 10. This is of no further significance to the operation of the method.

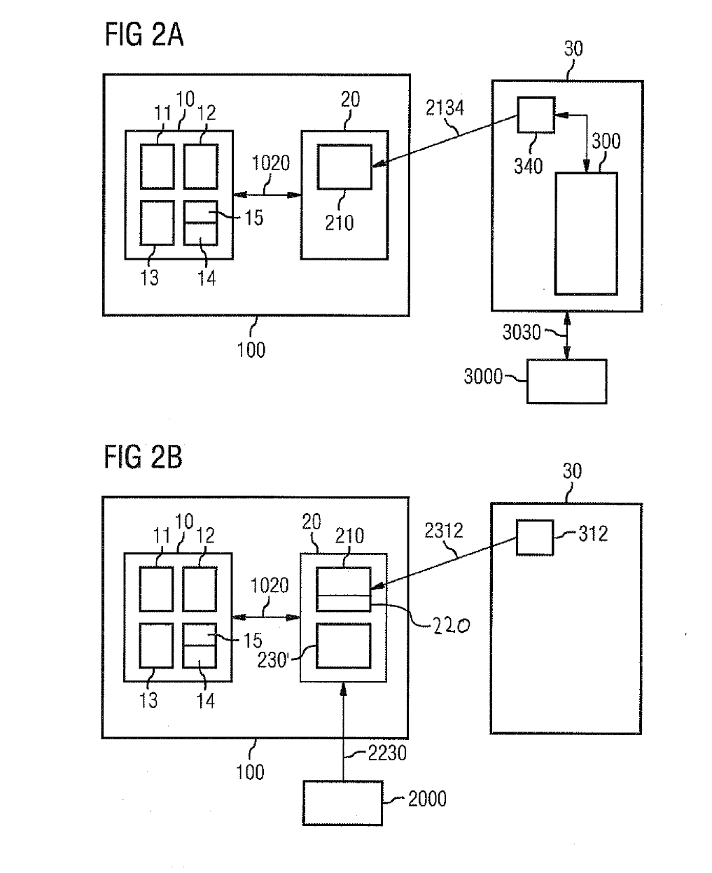

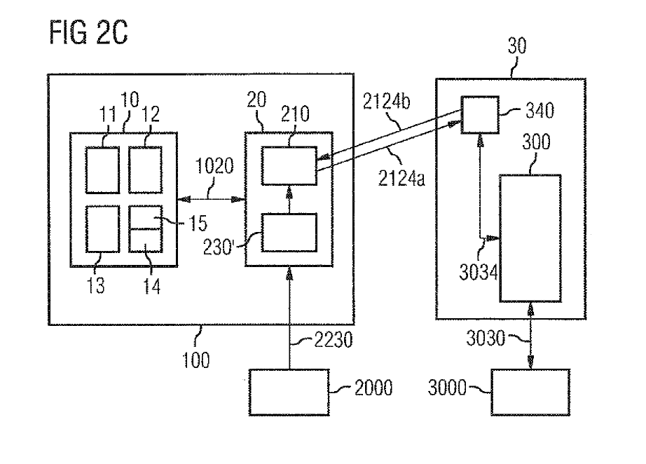

In FIGS. 2a-2c, embodiments of the method are explained in more detail. FIG. 2a shows a first method for transmitting specific data from the data processing installation 30 to the tachograph 10, which is arranged in a vehicle 100. The data processing installation 30 communicates with the external information source 3000 via a connection 3030. The information source 3000 provides the data processing installation 30 with information about the traffic situation on a plurality of roads in a plurality of regions. This information is recorded by the server 300. The information is then aligned in the server 300 with the information about the vehicle 100, the tachograph 10 and the driver of the vehicle 100 which is held in the data processing installation 30. By way of example, the planned route of the vehicle 100 is aligned with the information recorded by the external information source 3000 such that the vehicle 100 is sent only that information 2134 relevant to the planned route of the vehicle 100. In this case, the relevant information 2134 is transmitted to the GSM module 210 as specific data by the GSM module 340 of the data processing installation 30, said GSM module 210 being arranged in a communication controller 20. When the communication controller 20 has received the information 2134, said information is transmitted to the control unit 13 of the tachograph 10 via the connection 1020. The control unit then instructs either the menu control or display 11 or the printer 12 and/or the voice output device to output the information.

Such a method allows the infrastructure of a system, as is described in FIG. 1, for example, to be used to design a simple telematic solution for a vehicle 100 with minimal complexity. A further possible application, which does not require the external information source 3000, would be the transmission of an updated data processing program version for the tachograph 10 by the data processing installation 30 or an updated firmware version of the tachograph 10. These would likewise be transmitted to the tachograph 10 by the data processing installation 30 following alignment with the available information about the current version of the software (i.e. of the data processing program) and the firmware of the tachograph 10, whereupon the update is performed at a suitable time, which can be determined automatically by the tachograph 10—for example in a quiescent phase—or manually by the driver of the vehicle 100. The same applies to an update for the data processing program or the firmware of the communication controller 20. The fact that the data processing program of the tachograph 10 or firmware of the tachograph 10 has been updated can again be indicated by a display on the menu control or display 11 or a printout from a printer 12 and/or an output from the voice output device. This also applies to a failed update in the tachograph 10. In this context, it makes sense for the tachograph 10—in the event of a failed update—to be able to continue to access the firmware available before the attempt at the update or the previously available data processing program so that the operation of the tachograph 10 is assured at least until the next visit to a service center or repair workshop. Specific implementation options for such backup methods are sufficiently well known and beyond the scope of the present disclosure.

A further exemplary embodiment of an appropriate method is shown in FIG. 2b. In this case too, the vehicle 100 has a tachograph 10 and a communication controller 20 which has a module for wireless data transmission 220, which can receive radio waves, and additionally a GPS module 230′. In this case, the GPS module 230′ communicates with the satellite system 2000 and receives position data 2230 for the purpose of inherent localization and for localizing the vehicle 100. From the data processing installation 30, the module for wireless data transmission 220 receives specific data 2312 about a module 312 of the data processing installation 30, which module may correspond to the WLAN access point 350 from FIG. 1. The specific data is sent using a radio wave protocol, which corresponds to the TMC method known in the prior art. The module for wireless data transmission 220 transmits this data to the control unit 13 of the tachograph 10 via the connection 1020. The tachograph 10 also receives the position data 2230 and aligns the position data 2230 with the specific data 2312 such that the traffic information which is relevant to the vehicle 100 is stored in the memory 15, whereas the rest is erased. The data which has been aligned in the memory 15 in this manner and is relevant can then be output via the menu control or display 11, the printer 12, and/or the voice output device.

A further variant of the method is shown in FIG. 2c. In this case, the GPS module 230′, which is again accommodated in the communication controller 20, receives the position data 2230 via the satellite system 2000. This data is transferred to the GSM module 210, which transmits it as data 2124a to the GSM module 340 of the data processing installation 30. The GSM module 342 transmits the data 2124a via the connection 3034 to the server 300, which receives traffic-related data 3030 via an external information source 3000. Next, the position of the vehicle 100 is aligned with the originally planned route of the vehicle 100, recommendations for a change of route are possibly prescribed and said changed route is aligned with the traffic information 3030. Route guidance ascertained in this manner is again transmitted to the GSM module 340 via the connection connection 3034 and is transmitted as specific data 2124b to the GSM module of the communication controller 20. The latter buffer-stores said data in a memory while the connection between the data processing installation 30 and the communication controller 20 is capped. Next, the specific data 2124b is transmitted to the tachograph 10 via the wire-based connection 1020, and the specific data 2124b is then output via the menu control or display 11, the printer 12, and/or the voice output device, so that the driver can see and/or listen to them.

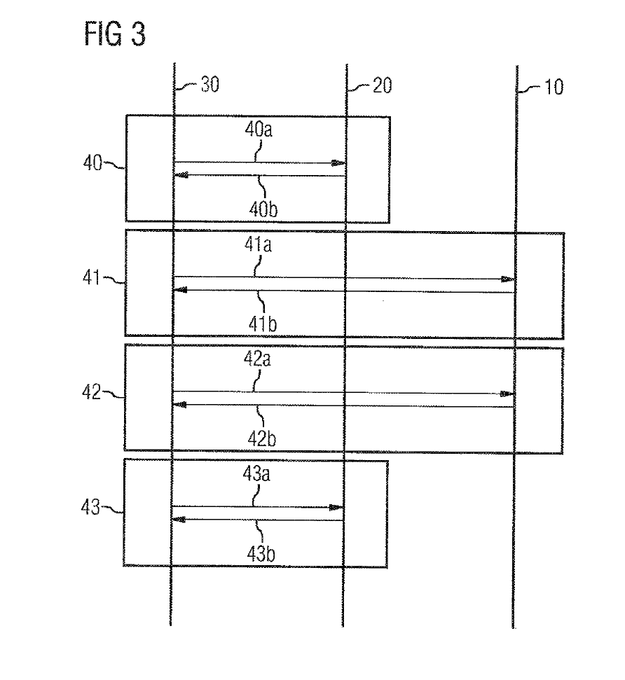

FIG. 3 is an exemplary embodiment of the method of updating a data processing program of the tachograph 10 and of updating a piece of firmware of an communication controller 20 with the inclusion of the authentication step.

In the embodiment shown here, the communication controller 20 communicates with the data processing installation 30 via a GSM or UMTS connection. First, the data processing installation 30 establishes that updated data processing programs are available for the tachograph 10 or the communication controller 20. This is accomplished by aligning an internal database in the data processing installation 30 with the versions which are present in the tachograph 10 and the communication controller 20.

Next, the data processing installation 30 sends a text message 40a to the communication controller 20 as part of a registration 40, with the instruction to register on the data processing installation 30 at the next possible time. This registration 40b takes place at the next possible time, the registration on the data processing installation 30 not being forcibly tied to GSM protocol but rather likewise being able to be a connection by means of the module for wireless data transmission 220.

Next, authentication 41 takes place. In this case, the data processing installation 30 authenticates itself on the tachograph 10, said authentication 41a being executed in signed and encrypted form. This can involve the authentication taking place using the data present on the authentication apparatus 330. In return, the tachograph 10 authenticates itself on the data processing installation 30. This authentication 41b comprises the data from the tachograph and from the driver's card inserted into the tachograph. In this case, the authentication process is brokered by the communication controller 20. The communication controller may be arranged in the tachograph 10, i.e. may share a housing with it or even be accommodated on the same printed circuit board. When the authentication 41 has been performed successfully, the data processing installation 30 uses an update 42 to transmit the updated version of a data processing program for the tachograph 10 in the form of specific data 42a. If this transmission is successful, the tachograph 10 sends a success notification 42b to the data processing installation, which in turn records that the specific data, in this case in the form of an update, have been transmitted. Preferably, a further notification can be sent at a later time, providing notification of the successful update of the data processing program in the tachograph 10 of the data processing installation 30.

In a further update step 43, the firmware of the communication controller 20 is updated. This is done by specific data 43a, which is confirmed by the message 43b. Next, the connection between the data processing installation 30 and the tachograph 10 is severed for an indefinite time, the data processing installation 30 and also the tachograph 10 being able to request communication again at regularly or irregularly stipulated times.

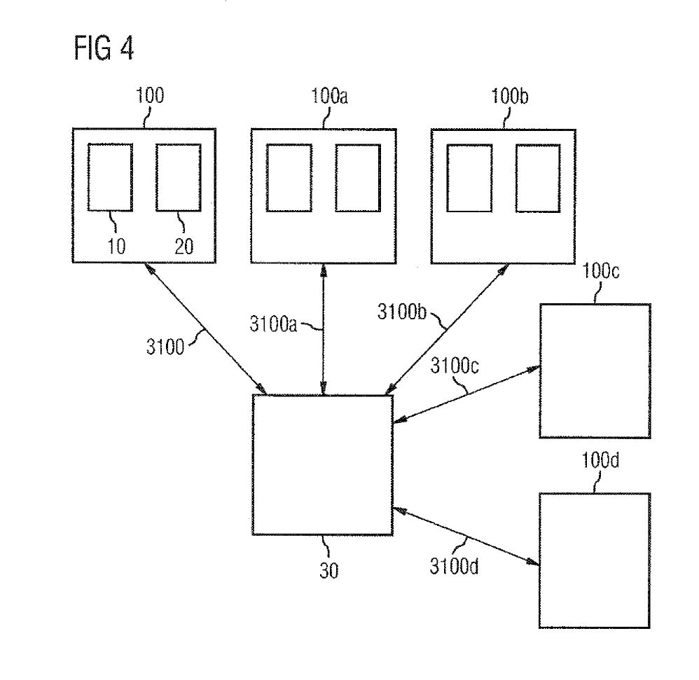

FIG. 4 is intended to describe the operation of the system and of the method when a plurality of vehicles are present. FIG. 4 schematically illustrates vehicles 100, 100a, 100b, 100c, 100d. Similarly, the data processing installation 30 is again part of the system. As already described with reference to FIG. 1, the data processing installation 30 receives information from the external information source 3000 and the information is aligned by a server with information for the individual vehicles 100 to 100d such that the interchanged specific data 3100, 3100a, 3100b, 3100c, 3100d may each be different on account of different route guidance for the vehicles, which are stored in the data processing installation 31 as a data record, or on account of the different communication methods between the tachograph and the data processing installation. In this case, the vehicles may be equipped differently, i.e. some may have an apparatus for inherent localization, but this is not compulsory. It is also possible for the tachographs 10 of the individual vehicles 100 to 100d to differ in terms of the loaded data processing programs, the firmware or the model type of the tachograph. The different parameters are managed by the data processing installation 30. In this context, the server 300 from the exemplary embodiment in FIG. 1 may have a database, for example.

In another exemplary embodiment, the specific data 3100, 3100a, 3100b, 3100c, 3100d are updated versions of the data processing programs of the tachographs arranged in the vehicles 100 to 100d. In this case, the vehicles 100, 100a and 100b have the same tachograph model with the same data processing program version. Accordingly, the specific data 3100, 3100a, 3100b are also identical apart from the different protocol data (on account of the respective transmission standard). The vehicle 100c has a different tachograph type. Accordingly, the updated software is not necessarily the same as in the vehicles 100 to 100b. This can be seen in the fact that the specific data 3100c differ from the aforementioned specific data 3100, 3100a, 3100b. The vehicle 100d has a very out-of-date version of the data processing program of the tachograph. The model type of the tachograph is identical to the tachograph arranged in the vehicle 100c. Therefore, the specific data 3100c and 3100d also differ.

The exemplary embodiments shown here merely show a few possibilities and are naturally not all the possible variants of the method according to the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method for transmitting data via a transmission path having a wireless path portion between at least one tachograph arranged in a vehicle and a data processing installation, that is a distance from the vehicle, the method comprising:
establishing a connection for wireless data transmission between at least one of a GSM module and a module for wireless data transmission coupled to the tachograph and the data processing installation;
instructing the at least one tachograph by the data processing installation to receive specific data;
at least one of:
authenticate the data processing installation with the at least one tachograph, and
authenticate the at least one tachograph on the data processing installation; and
transmitting specific data from the data processing installation to the at least one tachograph.

16. The method as claimed in claim 15, further comprising storing the specific data by the tachograph.

17. The method as claimed in claim 15, wherein the specific data transmits information, the method further comprising at least one of:
displaying at least a portion of the information by a menu control of the tachograph,
printing at least a portion of the information by a printer associated with the at least one tachograph, and
outputting at least a portion of the information by a voice output device associated with the tachograph.

18. The method as claimed in claim 17, wherein the information comprises at least telematic information.

19. The method as claimed in claim 15, wherein the specific data comprises at least an update for a data processing program of the tachograph.

20. The method as claimed in claim 15, wherein a plurality of tachographs are present, and the data processing installation communicates with each of the plural tachographs independently of one another.

21. The method as claimed in claim 15, wherein the at least one of the GSM module and the module for wireless data transmission is arranged in a communication controller, and a communication controller is coupled to the tachograph by a further interface.

22. The method as claimed in claim 21, wherein the specific data is buffer-stored in the communication controller.

23. The method as claimed in claim 22, wherein the specific data comprises an update for a data processing program of the communication controller.

24. A system for transmitting data via a transmission path a portion of the transmission path being a wireless path, comprising:
a data processing installation arranged outside of a vehicle; and
at least one tachograph, arranged in the vehicle comprising at least one of:
at least one associated GSM module configured for wireless data transmission with the data processing installation and
an associated module configured for wireless data transmission with the data processing installation,
wherein the data transmission between the data processing installation and the at least one of the GSM module and the module for wireless data transmission is wireless.

25. The system as claimed in claim 24, wherein the at least one of the at least one GSM module and the module for wireless data transmission is arranged in a communication controller connected to the at least one tachograph.

26. The system as claimed in one of claim 24, wherein the at least one tachograph comprises an associated apparatus for inherent localization.

27. The system as claimed in one of claim 24, wherein a plurality of tachographs are present.

28. The system as claimed in one of claim 24, wherein the system is configured to:
establish a connection for the wireless data transmission between the at least one of the at least one GSM module and the module for wireless data transmission and the data processing installation;
instruct the at least one tachograph by the data processing installation to receive specific data;
at least one of:
authenticate the data processing installation with the at least one tachograph, and
authenticate the at least one tachograph on the data processing installation; and
transmit the specific data from the data processing installation to the at least one tachograph.

29. The method of claim 15, wherein the data is transmitted wirelessly at least via a subsection of the transmission path, and the tachograph is connected to at least one of a GSM module and a module for wireless data transmission.
